(19) United States
(12) Patent Application Publication
(10) Pub. No.: US 2018/0365672 A1
(43) Pub. Date: Dec. 20, 2018

(54) Integrated Mobile Point-Of-Sale And Point-Of Consumption Platform

(71) Applicant: Fresh Press LLC, San Francisco, CA (US)

(72) Inventor: Nelson Apollo Lee, Campbell, CA (US)

(21) Appl. No.: 16/010,067

(22) Filed: Jun. 15, 2018

Related U.S. Application Data
(60) Provisional application No. 62/521,187, filed on Jun. 16, 2017.

(51) Int. Cl. G06Q 20/20; G06F 17/30

(52) U.S. Cl. CPC G06Q 20/208; G06F 17/30864

(57) ABSTRACT

A distributed system is provided. The system includes a point-of-sale system adapted to conduct a transaction with one or more consumable items and a database coupled to the point-of-sale system over a communication network. The database is adapted to map the transaction with the one or more consumable items to an indicator of authorized entity. A point-of-consumption system is coupled to the communication network and is adapted to permit access to the one or more consumable items responsive to the indicator of an authorized entity.

### CROSS REFERENCE TO RELATED PATENT APPLICATION(S)

The present disclosure claims the priority benefit of U.S. Provisional Patent Application No. 62/521,187, filed on Jun. 16, 2017, and entitled “System and Methods of Integrated Mobile Point-of-Sale and Point-of-Consumption Platform”, which is herein incorporated by reference in its entirety.

### BACKGROUND

### Field of the Invention

This invention relates to point-of-sale and point-of-consumption systems.

### Background of the Invention

Point-of-sale systems to purchase a product or service typically include either a cash transaction or an electronic transaction the use of credit cards, debit cards, gift cards, tokens, accounts, special tickets or coins, as well as systems such as Apple Pay and Square. Virtual tokens or accounts (e.g., a name, e-mail address, phone number) can also be used to make a purchase.

### BRIEF DESCRIPTION OF DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a flow chart depicting an overall operation in accordance with one embodiment of the invention;

FIG. 2 is a flow chart depicting retailer operations in accordance with one embodiment of the invention;

FIG. 3 is a flow chart depicting consumer relations in accordance with certain embodiments of the invention;

FIG. 4 is a flow chart showing back-end and server-side operations in accordance with one embodiment of the invention;

FIG. 5 is a front view of a juicer with a pack mounted therein;

FIG. 6 is a front view of a portion of a juicer in accordance with certain embodiments of the invention;

FIG. 7 is a flow chart depicting a method of connecting a juicer to a network in accordance with one embodiment of the invention; and

FIG. 8 is a side schematic view of a juicer including a controller.

### DETAILED DESCRIPTION

At the point-of-sale, a customer makes a payment to a merchant in exchange for goods or services. Thus, a point-of-sale system can monitor and/or control the time and place where a product or service is purchased. Thus, in a conventional point-of-sale system where a consumer purchases a product in a store, the consumer cannot leave the premises without first paying for the item. With regard to digital purchases, the merchant can prevent a download until payment is received.

While limiting or controlling the point-of-sale may be relatively simple, limiting or controlling the point-of-consumption for physical products can be difficult. Indeed, after a consumer makes a purchase, the consumer can choose when and where to make use of the product. The merchant has no control over product consumption at this point.

In some situations, however, sellers may wish to limit the consumption of purchased products to a certain area, such as within the premises of the sale. Similarly, in certain situations, sellers may wish to prevent the consumption within their premises of products brought in from elsewhere.

Systems and methods in accordance with embodiments of the present invention thus control a point-of-consumption associated with a purchased product. Though discussed below with reference to a single-serve juice pack, the present invention is not so limited and the system and methods described herein may be employed with any beverage system or other product or consumable item. Additionally, a consumable item as discussed herein is not strictly limited to an ingestible product, but can be any product that is effectively spent after use or where product use is desired to be limited to certain geographic locations, certain time restrictions, a fixed number of uses, or the like.

As used herein, the term “retailer” may include a traditional retail outlet such as a coffee shop, deli, convenience store, etc. Alternatively, a “retailer” may be a subsidized outlet, such as an employer-sponsored or subsidized cafeteria or cafe or other such location. As such, the terms “retailer”, “company” and “employer” may be used substantially interchangeably. Similarly, the terms “consumer”, “purchaser” and “employee” may also be used substantially interchangeably herein.

In one embodiment, a single-serve juice pack may be purchased by a consumer for use in a juice press. Aspects of such a juice press will be described below, though examples of such juice presses and juice packs are described in the Applicant's PCT publication WO20141182423 filed Apr. 18, 2014 and Applicant's PCT application PCTIUS2017020428 filed Mar. 23, 2017, each of which is hereby incorporated by reference in its entirety. Such juice presses may be provided by the seller for immediate use of the purchased juice pack, or owned by individual consumers for home use. Traditionally, the only way to ensure that a user or purchaser only consume the product in the store would require physically preventing the user from leaving the store with the juice pack.

Certain embodiments of the invention address this problem by, for example, integrating a system for point-of-sale and point-of-consumption of single-serving juice packs. As described in detail below, some embodiments may be used by a company stocking juice packs for sale on the premises which are limited for use in juicers also located on the premises. In one embodiment, for example, the company may negotiate a discounted sales price for juice packs sold exclusively to its employees for consumption on the premises. Similarly, in another embodiment, a business may buy products at a discounted rate for its employees for their use and consumption exclusively on the employer's premises. It should be understood that the systems and methods can be applied generally to other systems and is not limited specifically to the described scenarios.

In one embodiment, the point-of-sale system may be implemented on a mobile device, such as a smart phone or tablet, to create a mobile point-of-sale system. In such an embodiment, a mobile point-of-sale system may support dynamic pricing of a product at different retail premises. Optionally, the point-of-sale system may communicate with a manufacturer's system to check the validity of the product before a purchase can be made. In another embodiment, for example, the mobile point-of-sale system may associate a virtual token unique to the retail premises with a unique identifier of the product by using a mobile application to scan the product's QR code.

In another embodiment, a device that controls the consumption of the product (e.g., the juice press) may be configured with a virtual token unique to the retail premises. The device may communicate with the manufacturer's server (e.g., a service executing in a cloud-based system) over the Internet, for example, to form a point-of-consumption system. Such a point-of-consumption system may control which products can be consumed at which locations under a specified time period (e.g. juice pack expiration date). This may prevent an employee or other user from taking a juice pack home without paying for it, and then attempting to press it on a different machine.

In one embodiment, after the user has purchased the product (e.g., the juice pack), the purchaser may attempt to consume the product by using a point-of-consumption device (e.g., the juice press). The point-of-consumption device may identify a unique identifier associated with the product, look up the virtual token of the product from the point-of-sale, and determine if it matches the virtual token of the point-of-consumption device located at the retail premises. Token validation may be performed, and the product may be allowed to be consumed, or rejected if the tokens do not match.

In one embodiment, each juice pack may be associated with a unique digital identifier. When purchased by a retailer or similar entity that desires to distribute the packs for consumption, each juice pack may be associated with a virtual token unique to the retailer and stored in a virtual token database (e.g., in a cloud-based system). Such a virtual token database may be part of or separate from the juice pack database.

When a consumer attempts to use the juice pack in a juice press, the juice press or other device may check the pack's identifier (e.g., by scanning an identifier printed on the juice pack) and check if the pack is associated with a specific juice press (e.g., by performing a lookup to the virtual token database). The system may compare an identifier of a specific juice press with an entry in the virtual token database to determine if the specific juice pack is permitted to be pressed in the identified juice press. If the juice press and pack are properly associated (e.g., the press was purchased at a retail outlet and the press is associated with the retail outlet), the pack may be squeezed in the usual manner. The place of consumption of the pack may thus be controlled by the retailer. If a consumer attempts to use the pack in another juice press not owned or otherwise controlled by the retailer, the juice press may not press the pack, thereby preventing its consumption. In this manner, a system in accordance with the invention may monitor and control both the point-of-sale and the point-of-consumption of the juice pack.

In another embodiment, each juice pack may be associated with a unique digital identifier. As before, each retailer may be associated with a virtual token, and each pack the retailer is selling may also be associated with that virtual token. In this embodiment, the virtual token may be further associated with geographical locations within which the retailer would allow consumption of the pack—for example, their stores. The virtual token may also be associated with a time period during which the packs may be used.

When the consumer inserts the pack into a juice press, the juice press may determine whether it is in the correct location within the correct time frame before pressing the pack. In the virtual token database, each virtual token may include one or more parameters that restrict when, how, and where the juice pack or other consumable item may be consumed. Optionally, the distributor of the consumable item may selectively control the manner by which the consumable item may be used. In this manner, the system may also monitor and control the point-of-sale and point-of-consumption of the pack.

Certain embodiments may create a record of when and where each juice pack is sold and used to enable retailers to track and analyze the data to inform future operations. Optimally, such information may be used to trigger other actions, such as alerting the purchaser of point-of-sale regarding impermissible use of the consumable item, reordering the item and shipping it to the location where the consumable item was consumed, or any other action known to those in the art.

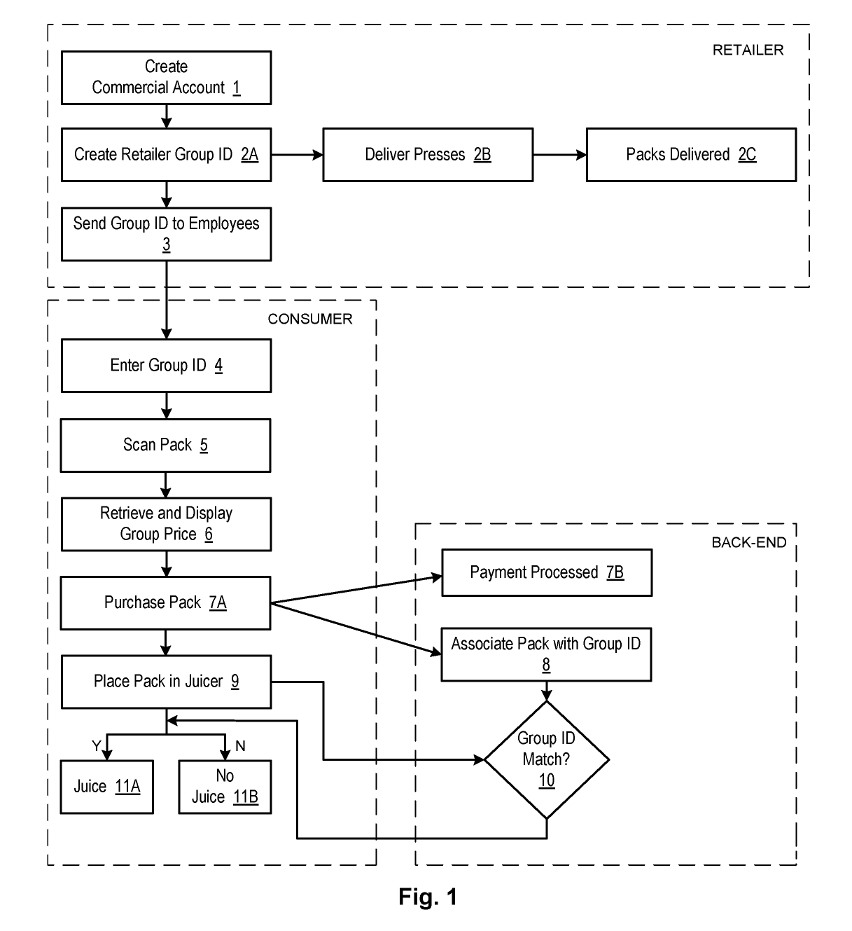

Referring now to FIG. 1, shows a flow chart illustrating a summarized overview of the integrated point-of-sale and point-of-consumption monitoring system. Each part of the process will be described in detail further below. The uppermost delineated section of the flow chart describes parts of the system that the company or retailer are responsible for. A retailer interested in beginning to sell packs on their premises would begin by creating 1 a commercial account. In creating a commercial account, a unique Group ID may be created 2A for the retailer. This Group ID may be an identifier that is further associated with details about the company in the juicer company's database, as described in detail further below. Juice presses, or “juicers,” for creating juice using the packs and programmed may be associated with the company's Group ID and delivered 2B to the company's premises. Packs containing food matter for juicing may be imbued with their own unique identifiers are requested by the company for local sale and delivered 2C. The company may then send 3 Group ID information to its employees to enable the employees to purchase the packs, which may be offered at a discounted rate.

As shown in FIG. 1, certain parts of the overall process are the consumer's responsibility, while other parts of the operation may be handled on the back-end. For instance, when employees receive the Group ID from their companies, they may enter the information into an associated smart device application 4. This application, and by extension the employee's phone, tablet or other computing device, may be associated with the entered Group ID. Going forward, an application and a phone are described, but it should be understood that any Internet-enabled smart device with the ability to scan an information-containing region on the packs may be used. The application and the associated process are described in detail below.

When an employee desires to purchase and use a pack, they may retrieve the pack from their retailer and scan 5 the pack with their phone. The application may retrieve and display information about the pack (e.g., from an on-line database that stores information regarding each pack), including the price of the pack associated with the employee's company. The price of the pack may be based on the application's Group ID 6, as described in detail below. If the employee chooses to purchase 7A the pack, the payment may be locally or remotely processed 7B. The application may then permanently associate 8 the pack with the application's Group ID. The time, date, and location of purchase, if available, may also be recorded (e.g., in the database). The employee may then place 9 the pack in the juicer.

The juicer may query 10 the remote pack database and determine if the Group ID associated with that pack matches the Group ID associated with the juicer. In one embodiment, the juicer (or other such device) may be connected to the Internet to allow it to check the database. If the two Group IDs match, the juicer may proceed to make juice 11A using the pack. If they do not match, the juicer may not press 11B the pack and may flash an appropriate error message to the user, or otherwise provide an indication through, for example, the smart device, that an error occurred.

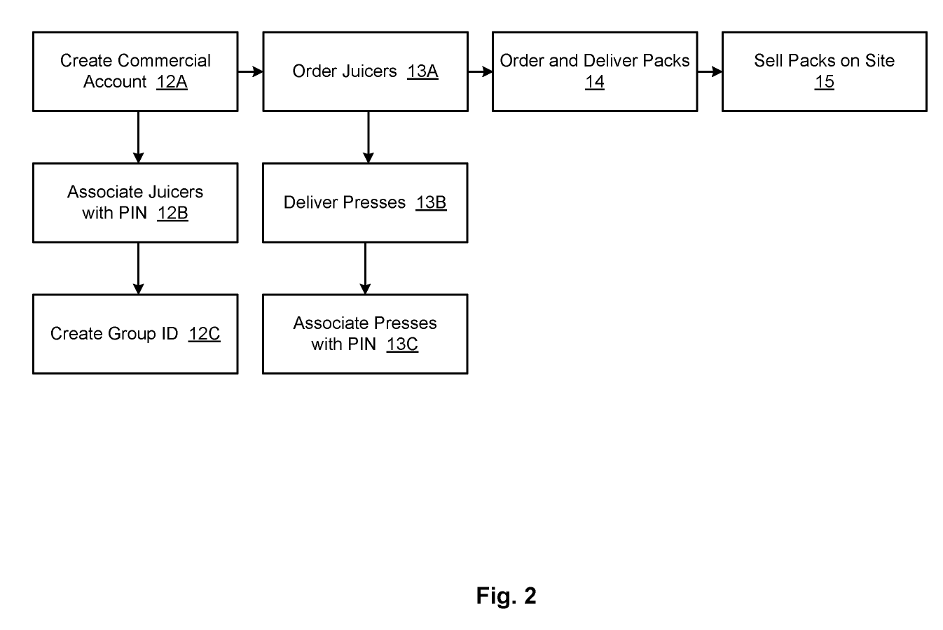

FIG. 2 shows a retailer's set-up operations in accordance with one embodiment of the invention. When a commercial account is created 12A, a PIN may also be created and associated 12B with the company. A Group ID associated with the company may be created 12C as well. The PIN may be associated with the Group ID and programmed into each juicer 13C ordered 13A by and delivered 13B to the company.

The company may order the packs 14 it wishes to sell or otherwise offer onsite 15. Prior to the actual purchasing/obtaining of the packs by the consumer, the packs may be entirely unaffiliated. Each pack may include a unique identifier that is conveyed on the pack by an information-containing region, along with details about the pack such as expiry date, contents, ideal temperature, allergen information, and other point-of-sale details. In some embodiments, such information-containing region may be a QR code, as described in more detail below. It should be further appreciated that the company need not “sell” the packs to its employees, but may merely offer them as an employee benefit. In such an embodiment, the employee may still obtain the pack through the described ways, but may not actually transfer money to the company.

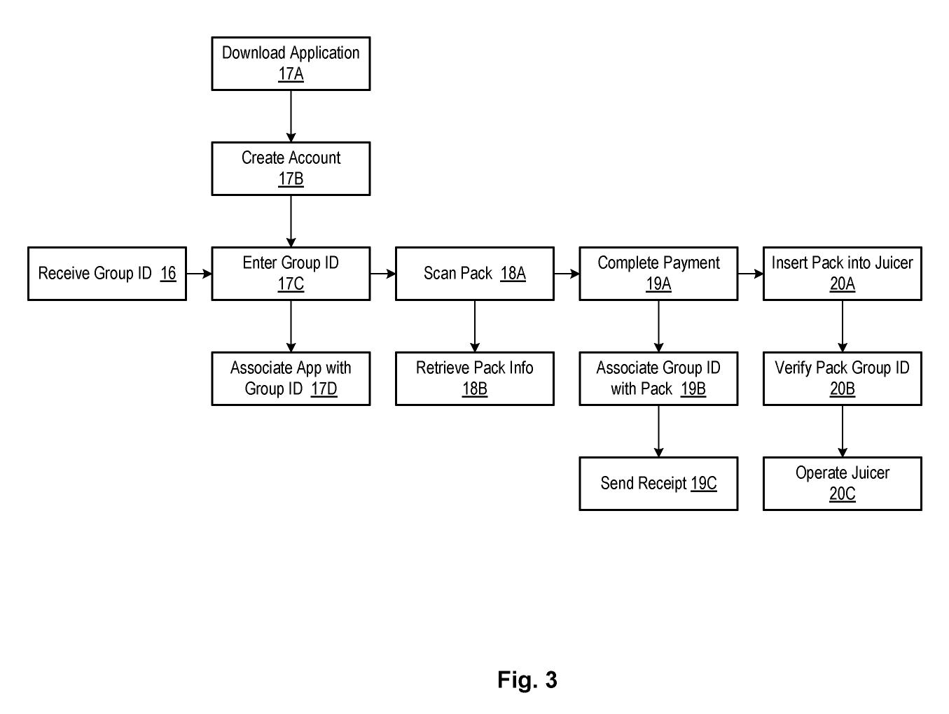

FIG. 3 shows one embodiment of the consumer side of the operation. An employee may receive 16 a Group ID from their employer, and may be prompted to download 17A the associated application. Once the application has been downloaded 17A, the employee or user may be prompted to create 17B a unique username and password to establish an account. A profile including address, phone number, email, and other biographical information may be provided by the user. In certain embodiments, the user may also be prompted to enter credit or debit card information. The user may be further prompted to enter the Group ID information from their employer 17C. The application may then query the central database to retrieve company details associated with the Group ID, after which the application may become associated 17D with that Group ID. Some embodiments of the present invention may allow applications to be associated with multiple Group IDs for different companies or locations, and may allow a user to select one Group ID upon logging into the application.

When an employee scans 18A a pack, the application may query the pack database to retrieve information about that particular pack, and may further query a central database to retrieve 18B a price associated with a Group ID linked to the application. In other embodiments, the application may also display the standard price of the pack, without the company's discount, to show the employee how much they are saving. If the employee opts to proceed with their purchase, they may be prompted to enter 19A payment information.

The payment information may be sent to and processed by a local or remote payment processing service. In some embodiments, the payment service may be provided by the juice company. In other embodiments, it may be provided by an external service. In certain embodiments of the application, the pack purchased may be simply tracked and added to a tab so that billing can be handled at a later time or by another entity, such as the employer themselves. If the payment goes through, the client may be notified and the pack may be linked 19B to the Group ID of the application in the pack database. A receipt, and in some embodiments a survey, may be sent 19C to the email entered by the employee during account set-up.

When the employee places the pack in the juicer 20A, the juicer may scan the pack and retrieve details about the pack from the pack database. In some embodiments, the juicer may display some or all of the information associated with the pack on an integrated display. The juicer may also retrieve the Group ID linked to the pack from the pack database. The juicer may further compare the Group ID linked to the pack to the Group ID linked to its own PIN to verify 20B that juicing of the pack is authorized. If the two Group IDs match, the juicer may proceed 20C with juicing or remain idle.

In some embodiments, the juicer may display a success or error message on an integrated display. In other embodiments, the juicer may also retrieve any potential recall information about the inserted pack, and/or compare the retrieved expiry date to the current date to determine whether the pack should be pressed. In some embodiments, any other restrictions stored in the database and associated with the pack may also be retrieved and enforced, such as parameters indicating when, how and where the pack or other consumable item may be used.

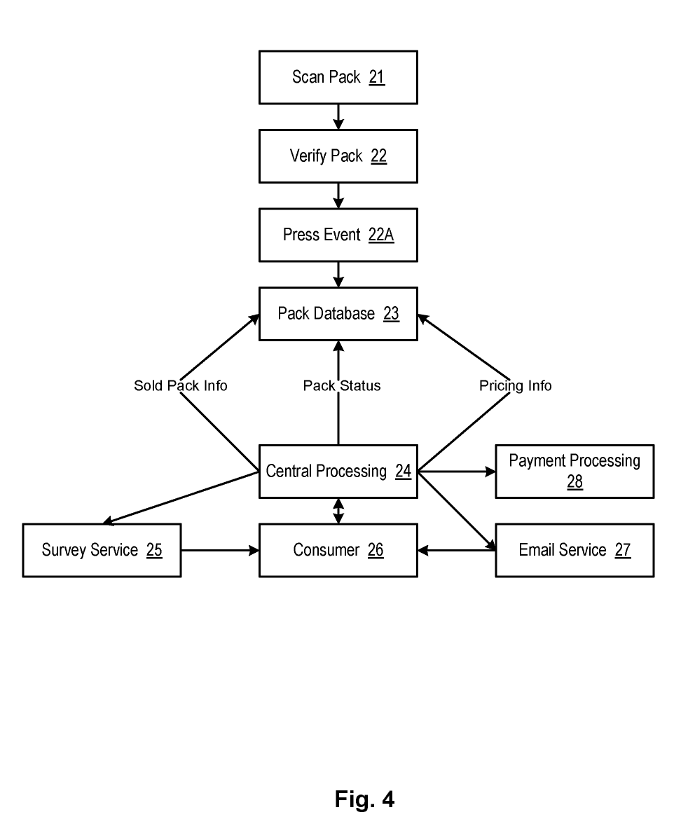

FIG. 4 describes back-end operations performed when a pack is inserted into a juicer in accordance with one embodiment of the invention. As the juice press scans 21 the pack via the QR code and associated scanner, for example. Information about the pack may be sent to and temporarily stored with a pack verification service. After pack verification, the juice press may send a “Press Event” 22A to the back-end to confirm the actual occurrence of a pressing event, since a user may decide not to consume the juice pack after pack verification.

The pack verification service 22 may query 23 the pack database for purchase information of the pack recorded at the time of purchase. If such data does not exist, the pack may be marked invalid and the juicer may not press the pack. In some embodiments, the pack verification service 22 may pull the pack status from the central processing service 24. The pack status may include any information about the pack from the pack database, such as whether the pack has been recalled, allergen information, expiry information, cold chain information, out of system information, and the like. In some embodiments, the pack status may further include local information from the juicer to facilitate a go/no-go decision with regard to dispensing the consumable item.

The pack database 23 may alert the central processing service 24 of the consumption record for analytics and company records. The central processing service 24 may also send this information to the payment processing service 28 for confirmation and bookkeeping points-of-sale. After consumption is recorded, the central processing service 24 may pass information to a survey service 25 and email service 27 to populate appropriate templates to be sent to the consumer/employee 26. In some embodiments, the consumer may view his or her consumption history via the application, which may retrieve the information from the central processing service 24.

In another embodiment of the system, the juicer may be pre-programmed with location information or contain hardware or software (e.g., GPS, Wi-Fi, or the like) that enables it to detect its geographical location. In this embodiment, when the company creates a commercial account, they may also enter coordinates of geographical areas within which the juicers associated with the company may be allowed to dispense juice from packs. When the employee inserts a pack into these juicers, the juicer may additionally query geographical restrictions associated with the Group ID from the central processing service 24. If its location is within the allowed geographical location and the pack Group ID matches the juicer Group ID, then the juicer may operate as usual.

In another embodiment of the system, when creating the commercial account, the company may designate time ranges during which their packs can be used. In this embodiment, the juicer also receives timing restriction information from the central processing service 24 when querying. It can then compare this information to its own internal clock to determine if a pack with a matching Group ID can be used.

In other embodiments of the system, geographical and timing restrictions can also be applied to the pack. In these embodiments, the employer may make the restrictions known when creating the commercial account. When an employee scans a pack, the app may query the central processing service 24 and pull any restrictions associated with the application's linked Group ID. If the phone is located outside of the allowed premises, or the phone reports a time outside of the allowed time range, the purchase may be blocked. In this scenario, the pack may not be linked to the Group ID in the pack database 23. If the employee then tries to press the pack anyway, the juicer may determine that the pack lacks a Group ID and may not press the pack.

As set forth herein, the described systems and methods may allow a company to keep track of the time of pack purchase and record the time of payment via scanning the pack with the application. They may also allow a company to control where and when the pack is purchased by placing restrictions on when the application may permit a payment. The systems and methods described may also allow a company to control where packs are consumed by only allowing packs to be used in juicers affiliated with the company, or within a location set by the company. Thus, systems in accordance with the invention may control and monitor both point-of-sale and point-of-consumption of the packs.

Turning now to the juicers, devices that extract juice from food matter are known in the art. As described herein, a juicer may be equipped with a reader suitable for scanning the information-containing region on a pack. A reader may include, for example, a camera, an optical scanner, a laser scanner, a magnetic reader, a radio frequency identification (“RFID”) tag reader, or any other suitable reader capable of reading information included on an associated juicer pack, as described below. The information region of the juicer pack may include features to store and recall the desired information, such as printed or digital indicator technologies including, but not limited to, bar codes, quick response (“QR”) codes, RFID devices, magnetic strips, a color bar or other similar graphics (e.g., printed graphics, embossed graphics and/or etched graphics), a time temperature indicator, and/or any other suitable readable medium known to those in the art.

In some embodiments of a juicer, the reader may be positioned on the juicer such that information on the pack may be read when the pack is loaded into the pressing chamber of the juicer. Accordingly, in some embodiments, the juicer may include pack supports and/or orientation features such that the information region on the juicer pack may be aligned with the reader on the juicer when the pack is correctly positioned and oriented within the juicer. However, it should be understood that in some embodiments, a reader may not require line-of-sight to read the information region of the pack. In one such embodiment, an RFID reader may only need to be within an appropriate range of an associated RFID tag.

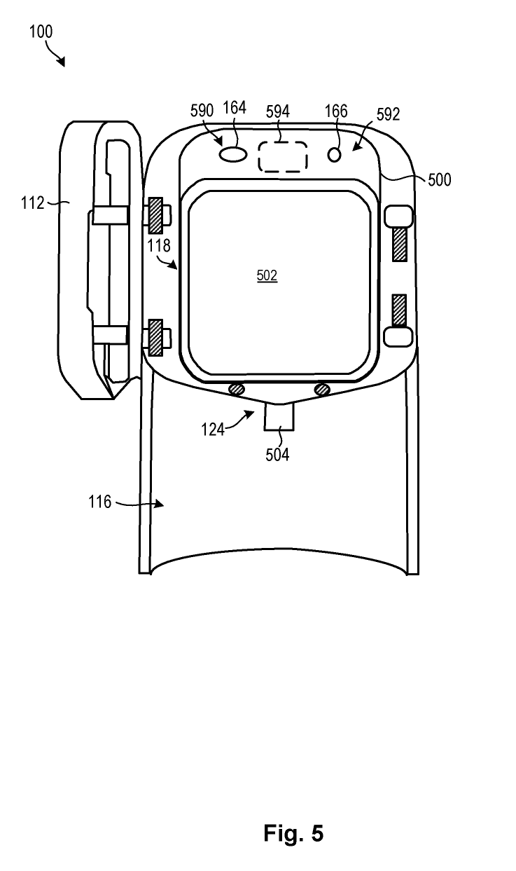

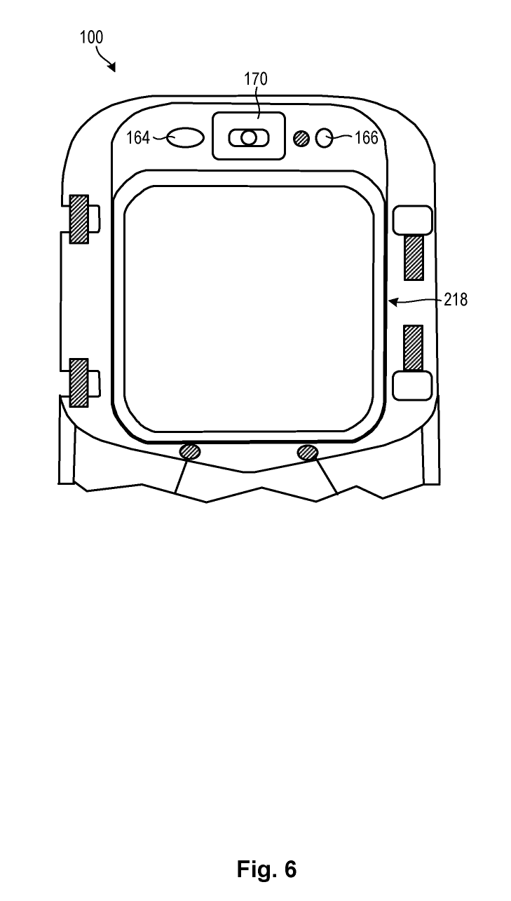

Turning now to FIGS. 5 and 6, one embodiment of a juicer 100 is shown. The juicer 100 may include a base 116 having an upper pressing region defined by platen 118 and press cover 112. When the pack 502 is placed in the pressing region, the outlet 504 of the pack may extend through the outlet 124 of the pressing region. The press 100 may also include a reader 170 positioned between pack supports 164 and 166, although other locations are also contemplated.

FIG. 5 shows the juicer with a pack 502 in position, where the pack 502 includes an information region 594 that may be aligned or oriented towards the reader 170 when the pack 502 is appropriately oriented and positioned within the pressing region. For example, in the depicted embodiment, the pack 502 includes an upper portion 500 that includes orientation cutouts 590, 592. Orientation cutouts may allow the pack to hang onto supports 164, 166 respectively. An upper pack portion 500 may also include an information region 594 on one side which contains printed media such as a QR code, or other such encoding information.

As shown in FIGS. 5 and 6, the information region 594 may be disposed on a side of the juice pack 502 that faces inwardly towards the reader 170 when the juice pack 502 is loaded in the juicer 100. The information region 594 of the juice pack 502 may thus face the reader 170 when the juice pack 502 is correctly loaded in the juicer 100. Such an arrangement may be appropriate for use with a reader 170 and information region 594 such as a QR code and associated optical or laser-based reader.

Although a juice pack 502 with an information region 594 located on an exterior surface of the juice pack 502 is described above, other configurations may also be suitable. For example, in some embodiments, an information region 594 may include a component located within an interior of a juice pack 502, such as an RFID tag located within laminated layers of the juice pack 502, or a printed tag (e.g., a QR code) that is viewable through one or more transparent layers of the juice pack 502. The current disclosure is not limited, however, to any particular configuration for an information region 594 on a juice pack 502.

In certain embodiments, the juice press 100 may also include a control system to control operations. In some embodiments, the juice press or juicer 100 may include a controller configured to control one or more aspects of the juicer operation. For example, a controller may include one or more circuits coupled to a drive mechanism and/or other active components of the juicer 100. A control circuit may provide control signals, such as a variable current, to a motor of the drive mechanism to control the force applied by a displaceable platen 118 used to squeeze the pack 502. In this manner, the platens 112, 118 may press chopped food matter contained in the juice pack 502 to squeeze juice from the food matter. The resulting juice may flow from the pack 502 through the outlet 504 and into a beverage container.

In some embodiments, the control circuits of a juicer 100 may control other juicer functions, such as operating a lock, operating a reader 170 to read information stored in an information region 594 of a juice pack 502, receiving operator input (such as commands for juicer operation), outputting information (e.g., to a visible display screen, indicator lights, juicer status information in electronic data form, and the like), and other functions. The control circuits may include any suitable components to perform the desired control, communication, and/or other internet required functions required by the system of the present disclosure.

For example, in certain embodiments, a control circuit may include one or more general purpose computers, a network of computers, one or more microprocessors, or other such devices for performing data processing functions. In some embodiments, the control circuit may further include one or more memories for storing data and/or operating instructions (e.g., volatile and/or non-volatile memories such as optical disks and disk drives, semiconductor memory, magnetic tape or disk memories, and the like), communication buses or other communication devices for wired or wireless communication (e.g., various wires, switches, connectors, Ethernet communication devices, WLAN communication devices, and the like), software or other computer-executable instructions (e.g., instructions for carrying out functions related to the present disclosure and/or controlling the load current control circuit as described above and other components), a power supply or other power source (such as a plug for mating with an electrical outlet, batteries, transformers, and the like), relays and/or other switching devices, mechanical linkages, one or more sensors or data input devices (such as a sensor to detect a position of the door of the juicer 100, a video camera or other imaging device to capture and analyze information regarding a juice pack 502 or other components, position sensors to indicate positions of a displaceable pressing surface 118, locking bolts, and the like), user data input devices (such as buttons, dials, knobs, a keyboard, a touch screen or other), information display devices (such as an LCD display, indicator lights, a printer, and the like), and/or other components for providing desired input/output and/or control functions.

In certain embodiments, the juicer 100 may include a reader 170 to read set-up information from a related information carrier. In addition or in the alternative, a smart device may communicate with the juicer 100 and the smart device may provide the necessary input device to configure the juicer 100. Thus, in one embodiment, a reader 170 on a juicer 100 may read a QR code or the like that contains wireless network information such as the name, IP address, and/or passcode for a network. While a physical card or other permanent structure may be used to present this information, in some embodiments, it may be desirable to generate the information for the reader 170 using a smart device such as a tablet, smart phone, or computer.

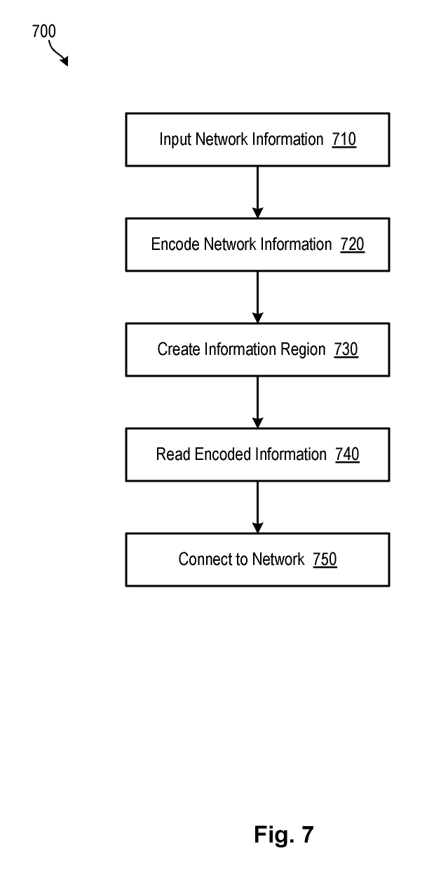

FIG. 7 illustrates one embodiment of a method 700 for connecting a juicer or other appliance to a network. First, the network information may be inputted 710 on a device, and encoded 720 as a QR code or other such code known to those in the art. The encoded information may then be displayed on a screen or printed out to create 730 an information region that may be read by a reader. The reader may read 740 the encoded network information. Once read, the juicer may connect 750 to the intended network. In this manner, the juicer may automatically connect to a wireless network without requiring a user to manually input the settings via a separate user interface.

Depending on the particular embodiment, a controller including one or more control circuits may be integrated with a juicer and/or located remotely from the juicer. For example, a remote control circuit may be provided in a separate unit adjacent the juicer, or in an offsite device such as a computer or a server that is connected to the juicer via a cable, a wireless connection such as a Wi-Fi network or Bluetooth connection, or any other suitable connection that allows for communication of signals between the juicer and the control circuit.

As noted above, in some instances a reader may be used to read information related to a juicer pack to control some aspect of juicer operation. For example, in certain embodiments, juicer packs containing different types of food matter, different combinations of food matter, and or food matter with varying degrees of freshness and/or juice content may require different pressing parameters to optimize juice extraction. The same combination of food matter within a juicer pack, however, may require different pressing parameters for different lots of produce prepared and packaged at different times and/or locations due to the produce having different juice content and/or being harder to press. A juicer pack may thus include information related to a desired pressing operation for extracting the juice from the food matter contained therein.

As noted above, a juicer may include a reader capable of reading information provided on an information region of a juicer pack. When a juicer pack is loaded in the pressing chamber, the reader may read the information on the juicer pack and press the juicer pack according to the desired pressing procedure encoded within that information region.

Depending on the embodiment, a juicer may adjust any suitable combination of operating parameters based on the information contained in the information region of a juicer pack. For example, such information may be used to determine, or may include commands for, an optimal speed profile, force profile, total displacement stroke, number of pauses, duration of pauses, number of press and/or retract cycles, distance of press and/or retract cycles, and/or any other appropriate operating parameter for a displaceable pressing surface or other component of a juicer during a pressing operation known to those in the art.

In some embodiments, the one or more pressing surfaces of a juicer may be temperature controlled (e.g., heated or cooled), and the information may determine an optimal temperature for the pressing surfaces during pressing. Further, in some instances a juicer may disable operation of the juicer (i.e., not press a particular juicer pack) based on the information. For example, if a juicer determines that a juicer pack is expired, has been recalled, has been stored improperly at elevated temperatures for too long (i.e., the cold chain has been broken as indicated by some thermal indicator readable by the reader or other device) or that a juicer pack has already been pressed, the juicer may not press the pack.

While network information encoded into an information region has been discussed above, it should be understood that other information may also be encoded into the information region, such as information related to setting up or modifying the performance of a device. This information may include, for example, device settings, operation commands, device names, and/or any other such information.

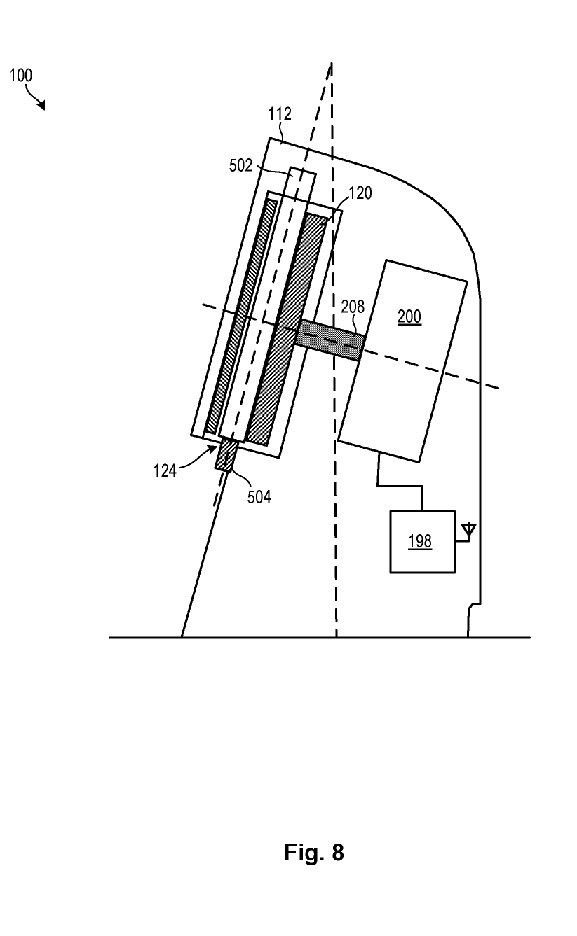

One illustrative embodiment of a juicer 100 having a control circuit is shown in FIG. 8. In particular, the juicer 100 may include a housing 112 including a controller 198, such as a microprocessor capable of connecting to the internet. In the depicted embodiment, the controller is coupled to the drive mechanism 200. The drive mechanism 200 may include a motor and drive component 208 to control one or more aspects of the pressing process (e.g., the force applied by the displaceable pressing surface 120). However, as noted above, the controller 198 may also be associated with other components of the juicer 100 (e.g. a lock and/or a reader), as the current disclosure is not limited to how many controllers 198 are included within a juicer 100 and/or with which components the controllers 198 are associated.

In some embodiments, the controller 198 may receive from the reader information about the inserted pack 502, such as the Group ID (or lack thereof) associated with it. It may then query the pack database and central processing service to receive general information about the pack, while also leaving a record that there was an attempt to use the pack. The controller may compare the Group ID of the pack with the Group ID of its PIN or its geographical location to determine if the pack may be processed. If so, the controller 198 may command the drive mechanism 200 to press the pack 502.

Various embodiments of smart phone applications may be used in connection with the present invention, including any suitable GUI designs and UX (“user-experience”) designs. In one embodiment, for example, a landing page may provide an option for the consumer/employee (i.e., user) to sign in or create a new account for the first time. Another interface may enable the user to enter their personal details for a new account. After signing up, the user may be prompted to input their credit card information. In certain embodiments, an application may utilize a smart phone's built-in camera to scan an information region of a pack. The application may scan for a QR code, for example, or for a bar code or other type of information region. When the code is identified, the application may query the pack database using the scanned information, and retrieve and display information about the pack shown.

If the user opts to purchase the pack, the application may present a screen to walk the user through the instructions of how to use the pack, including how to properly orient the pack within a juicer, how to orient the beverage container beneath the outlet, and how to actuate the activation button. Finally, the application may instruct the user to enjoy the beverage.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A system, comprising:
at least one consumable product having a unique identifier;
an entity authorized to offer the consumable product to a user, the entity having a virtual token associated therewith;
at least one server hosting a database mapping at least one unique identifier to at least one virtual token; and
a consumption device in communication with the server, wherein the consumption device selectively permits consumption of the consumable product in response to the unique identifier being associated with the virtual token in the database.

2. The system of claim 1, wherein the consumption device comprises a juice press.

3. The system of claim 1, wherein the consumable product comprises a juice pack.

4. The system of claim 1, wherein the entity comprises a retailer of the consumable product.

5. The system of claim 1, wherein the database associates the unique identifier with the virtual token in response to a purchase transaction including the consumable product.

6. The system of claim 1, wherein the database further comprises at least one parameter for determining whether consumption of the consumable product is permitted.

7. The system of claim 6, wherein the consumption device further selectively permits consumption of the consumable product in response to the consumable product satisfying the at least one parameter.

8. The system of claim 6, wherein the consumption device is configured to deny access to the consumable product in response to the consumable product failing to satisfy the at least one parameter.

9. The system of claim 6, wherein the at least one parameter is selected from the group consisting of a time-related restriction, a location-based restriction, and a juice press-based restriction.

10. The system of claim 1, further comprising a second database recording consumption of the consumable product.

11. The system of claim 1, wherein the consumption device further comprises a reader to scan the unique identifier of the consumable product.

12. A method, comprising:
providing at least one consumable product having a unique identifier;
associating a virtual token with an entity authorized to offer the consumable product to a user;
determining, via a server, whether the unique identifier is associated with the virtual token in a database; and
selectively permitting, via a consumption device, consumption of the consumable product in the event the unique identifier is associated with the virtual token in the database.

13. The method of claim 12, wherein the consumption device comprises a juice press.

14. The method of claim 12, wherein the consumable product comprises a juice pack.

15. The method of claim 12, wherein the entity comprises a retailer of the consumable product.

16. The method of claim 12, further comprising associating the virtual token with the unique identifier in response to a purchase transaction including the consumable product.

17. The method of claim 12, wherein the database further comprises at least one parameter for determining whether consumption of the consumable product is permitted.

18. The method of claim 17, wherein selectively permitting consumption of the consumable product further comprises determining that the consumable product satisfies the at least one parameter.

19. The method of claim 17, wherein the at least one parameter is selected from the group consisting of a time-related restriction, a location-based restriction, and a juice press-based restriction.

20. The method of claim 12, further comprising recording consumption of the consumable product in a second database.
